(19) United States
(12) Patent Application Publication
(10) Pub. No.: US 2015/0041265 A1
(43) Pub. Date: Feb. 12, 2015

(54) SHOCK ABSORBER

(71) Applicant: HITACHI AUTOMOTIVE SYSTEMS, LTD., Ibaraki (JP)

(72) Inventor: Mikio YAMASHITA, Zama-shi (JP)

(21) Appl. No.: 14/448,177

(22) Filed: Jul. 31, 2014

(30) Foreign Application Priority Data
Aug. 9, 2013 (JP) 166639/2013

(51) Int. Cl. F16F 9/32; F16F 9/18; F16F 9/36

(52) U.S. Cl. CPC F16F 9/325; F16F 9/36; F16F 9/18
USPC 188/315

(57) ABSTRACT

A damping force generating mechanism is housed in a casing disposed at a side of an outer tube of a tube type shock absorber and secured by tightening a nut. The damping force generating mechanism is connected through a passage member to a branch pipe of a separator tube forming an annular passage communicating with a cylinder. The passage member has support portions formed on an abutting surface abutting against a main body. The support portions are disposed at the inner peripheral side of a seal groove on the abutting surface so as to abut directly against the main body. As the nut is tightened, an axial force is transmitted to the support portions from the center and its vicinities of the main body, causing a flange portion of the passage member to be pressed against a flange portion of the casing, thereby securing the passage member.

### BACKGROUND OF THE INVENTION

The present invention relates to a shock absorber generating a damping force in relation to the stroke of a piston rod by controlling the flow of hydraulic fluid in a cylinder.

In a tube type shock absorber attached to a suspension system of a vehicle, e.g. an automobile, a damping force generating mechanism for generating a damping force is disposed at a side of a cylinder slidably fitted with a piston connected to a piston rod, as disclosed, for example, in Japanese Patent Laid-Open Publication No. 2013-11342. The shock absorber has a dual-tube structure in which an outer tube is provided around the outer periphery of the cylinder to form an annular reservoir between the cylinder and the outer tubs. In the reservoir, a separator tube is fitted over the cylinder to form an annular passage between the cylinder and the separator tube. Through the annular passage, the interior of the cylinder is connected to the damping force generating mechanism attached to the side wall of the outer tube.

Regarding the above-described shock absorber, which has a damping force generating mechanism disposed at a side of the cylinder part, there is a demand for reduction in size of the damping force generating mechanism, taking into account the mountability or the shock absorber to a suspension system.

### SUMMARY OF INVENTION

An object of the present invention is to provide a tube type shock absorber having a damping force generating mechanism disposed at a side of a cylinder part, which is capable of reducing in size.

The present invention provides a shock absorber including a cylinder having a hydraulic fluid sealed therein, a piston fitted in the cylinder, a piston rod connected to the piston and extended to the outside of the cylinder, an outer tube provided around the outer periphery of the cylinder, a separator tube provided between the cylinder and the outer tube and having a substantially circular cylindrical side wall forming an annular passage communicating with the interior of the cylinder, a substantially circular cylindrical branch pipe provided on the side wall of the separator tube to project radially outward in communication with the annular passage, a damping force generating mechanism connected to the branch pipe to generate a damping force by controlling the flow of hydraulic fluid induced by movement of the piston, a tubular casing secured to the side wall of the outer tube to house the damping force generating mechanism, and a passage member connecting together the branch pipe and the damping force generating mechanism. The passage member has a circular cylindrical portion fitted to the branch pipe of the separator tube and a flange portion formed on the outer periphery of one end of the cylindrical portion. The passage member is secured in the casing with the flange portion abutted between the casing and the damping force generating mechanism. The flange portion has an abutting surface abutting against the damping force generating mechanism. The abutting surface has an annular sealing portion abutting against the clamping force generating mechanism through an annular sealing member sealing between the flange portion and the damping force generating mechanism. The abutting surface further has an inner support portion disposed at the inner peripheral side of the sealing portion to abut against the damping force generating mechanism.

### BRIEF DESCRIPTION OF DRAWINGS

FIG. 1 is a vertical sectional view of a shock absorber according to an embodiment of the present invention.

FIG. 2 is an enlarged vertical sectional view of a damping force generating mechanism of the shock absorber shown in FIG. 1.

FIG. 3 is an enlarged end view of a passage member of the damping force generating mechanism shown in FIG. 2.

FIG. 4 is a vertical sectional view of the passage member shown in FIG. 3, taken along the line A-A.

FIG. 5 is a vertical sectional view of a modification of the passage member shown in FIG. 3.

### DESCRIPTION OF EMBODIMENTS

An embodiment of the present invention will be explained below in detail with reference to the accompanying drawings.

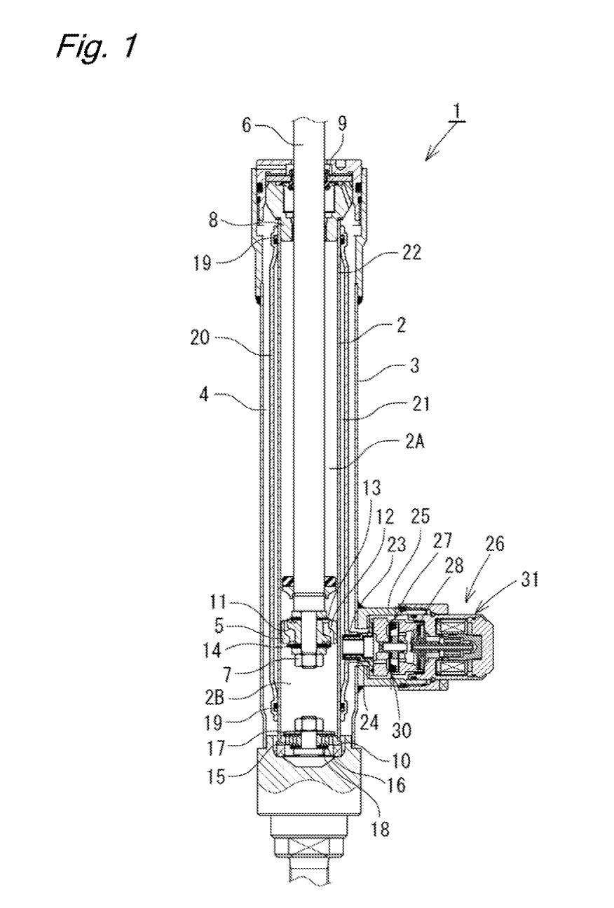

As shown in FIG. 1, a damping force control type shock absorber 1 as a shock absorber according to this embodiment has a dual-tube structure comprising a cylinder 2 and an outer tube 3 provided around the outer periphery of the cylinder 2. A reservoir 4 is formed between the cylinder 2 and the outer tube 3. The cylinder 2 has a piston 5 slidably fitted therein. The piston 5 divides the interior of the cylinder 2 into two chambers, i.e. a cylinder upper chamber 2A and a cylinder lower chamber 2B. The piston 5 has one end of a piston rod 6 connected thereto with a nut 7. The other end of the piston rod 6 extends through the cylinder upper chamber 2A to the outside of the cylinder 2 through a rod guide 8 and an oil seal 9, which are fitted to the upper end portion of the dual-tube structure comprising the cylinder 2 and the outer tube 3. The lover end portion of the cylinder 2 is provided with a base valve 10 dividing the cylinder lower chamber 2B and the reservoir 4 from each other.

The piston 5 is provided with passages 11 and 12 communicating between the cylinder upper and lower chambers 2A and 2B. The passage 12 is provided with a check valve 13 allowing only a flow of fluid from the cylinder lower chamber 2B toward the cylinder upper chamber 2A. The passage 11 is provided with a disk valve 14 that opens when the fluid pressure in the cylinder upper chamber 2A reaches a predetermined pressure to relieve the fluid pressure in the cylinder upper chamber 2A to the cylinder lower chamber 28.

The base valve 10 is provided with passages 15 and 16 communicating between the cylinder lower chamber 2B and the reservoir 4. The passage 15 is provided with a check valve 17 allowing only a flow of fluid from the reservoir 4 toward the cylinder lower chamber 2B. The passage 16 is provided with a disk valve 18 that opens when the fluid pressure in the cylinder lower chamber 2B reaches a predetermined pressure to relieve the fluid pressure in the cylinder lower chamber 2B to the reservoir 4. As hydraulic fluid, hydraulic oil is sealed in the cylinder 2, and the hydraulic oil and a gas are sealed in the reservoir 4.

The cylinder 2 has a separator tube 20 fitted thereover with sealing members 19 interposed therebetween at the upper and lower ends of the cylinder 2. An annular passage 21 is formed between the cylinder 2 and the separator tube 20. The annular passage 21 is communicated with the cylinder upper chamber 2A through a passage 22 provided in the side wall of the cylinder 2 near the upper end thereof. The separator tube 20 has a circular cylindrical branch pipe 23 projecting sideward from a lower end portion thereof. The branch pipe 23 is open at the distal end thereof. The side wall of the outer tube 3 is provided with an opening 24 in concentric relation to the branch pipe 23. The opening 24 is larger in diameter than the branch pipe 23. A circular cylindrical casing 25 is joined by welding or the like to the side wall of the outer tube 3 in such a manner as to surround the opening 24. The casing 25 has a damping force generating mechanism 26 installed therein. In this embodiment, the branch pipe 23 is formed integrally with the separator tube 20, but may be formed, separately from the separator tube 20.

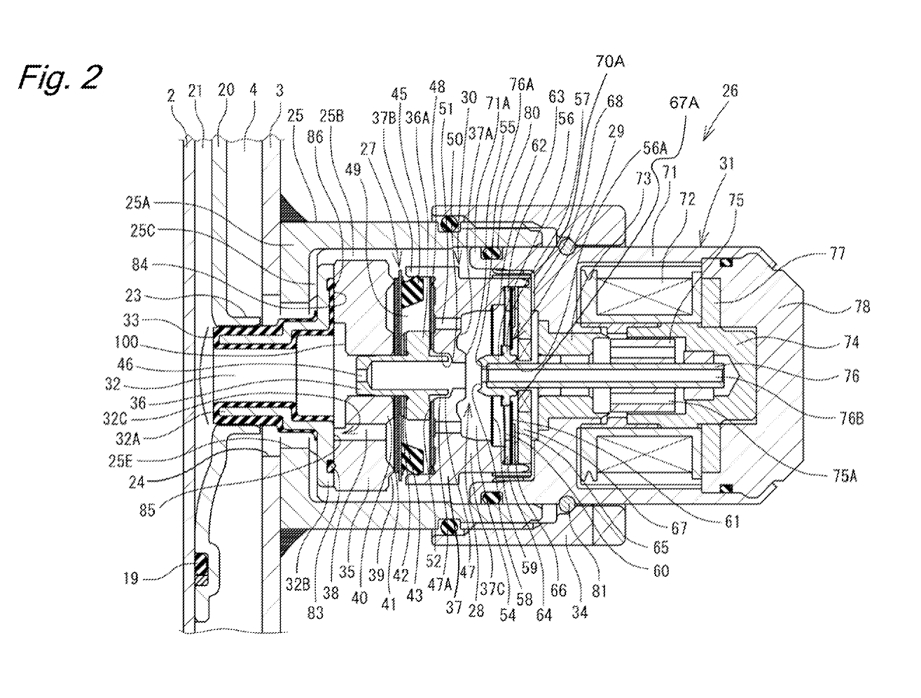

Next, the damping force generating mechanism 26 will be explained with reference mainly to FIG. 2.

The damping force generating mechanism 26 comprises a valve block 30 and a solenoid assembly 31 that actuates a pilot valve 28. The valve block 30 has a pilot type (back-pressure type) main valve 27, a pilot valve 28, which is a solenoid-driven pressure control valve controlling the valve-opening pressure of the main valve 27, and a fail-safe valve 29 provided downstream of the pilot valve 28 to operate when there is a failure. The main valve 27, the pilot valve 28 and the fail-safe valve 29 are incorporated as one unit into the casing 25. A passage member 32 is inserted into the casing 25 from an opening at the end thereof remote from the outer tube 3. Next, the valve block 30 and the solenoid assembly 31 are connected together into one unit and inserted into the casing 25, and the valve block 30 abuts against the passage member 32. Further, a nut 34 is screwed onto the casing 25 and tightened, whereby the valve block 30, the solenoid assembly 31 and the passage member 32 are secured in the casing 25.

The casing 25 has an inward flange portion 25A formed at one end thereof. The inward flange portion 25A has a plurality of radially extending notches 25C formed on the inner side thereof. The notches 25C and the opening 24 in the outer tube 3 provide communication between the reservoir 4 and a chamber 25B in the casing 25. The passage member 32 has a substantially circular cylindrical portion 32A and a flange portion 32B provided on the outer periphery of one end of the cylindrical portion 32A. The cylindrical portion 32A projects toward the cylinder 2 from an opening 25E of the flange portion 25A of the casing 25. The cylindrical portion 32A is fitted, into the branch pipe 23, and the flange portion 32B abuts against the flange portion 25A of the casing 25. In this way, the passage member 32 is secured. A part of the passage member 32 is covered with a sealing material 33. Consequently, the joint between the passage member 32 and the branch pipe 23 and the joint between a main body 35 (described later) and the passage member 32 are sealed with the sealing material 33. It should be noted that the structure of the passage member 32 will be detailed later.

The valve block 30 has a main body 35, a pilot pin 36, and a pilot body 37. The main body 35 has a substantially annular shape and abuts against the flange portion 32B of the passage member 32 at one end thereof closer to the outer tube 3. The main body 35 is provided with a plurality of circumferentially spaced passages 38 axially extending therethrough. The passages 38 communicate with a passage in the passage member 32 through an annul ax recess 100 formed at the one end of the main body 35. The other end of the main body 35 has an annular seat portion 39 provided at a position on the outer peripheral side of the openings of the passages 38. The annular seat portion 39 projects from the other end of the main body 35 in a direction away from the outer tube 3. The other end of the main body 35 further has an annular clamp portion 40 provided at the inner peripheral side of the openings of the passages 38. The annular clamp portion 40 also projects from the other end of the main, body 35 in a direction away from the outer tube 3. On the seat portion 33 of the main body 35 is disposed a main disk valve 41 constituting the main valve 27. The main valve 21 includes a retainer 42 and a washer 43 in addition to the main disk valve 41. The main disk valve 41 is preferably a plate-shaped valve.

The main disk valve 41 is seated at an outer peripheral portion thereof on the seat portion 39 of the main body 35. The inner peripheral portion of the main disk valve 41 is clamped, together with the retainer 42 and the washer 43, between the el amp portion 40 and the pilot pin 36. The main disk valve 41 has an annular sliding sealing member 45 fixed to the outer peripheral portion of the rear side thereof by a bonding method, for example, vulcanizing bonding.

The pilot pin 36 is in the shape of a stepped circular cylinder having a large-diameter portion 36A in the middle thereof. The pilot pin 36 has an orifice 46 formed at one end thereof. The one end of the pilot pin 36 is press-fitted into the main body 35. The large-diameter portion 36A and the clamp portion 40 clamp the main disk valve 41 therebetween. The pilot pin 36 has an other end. The other end of the pilot pin 36 forms a fitting portion that is press-fitted into a passage 50 in the pilot body 37. The other end of the pilot pin 36 has an outer peripheral portion chamfered at three equally spaced positions to form a chamfered portion 47 of substantially triangular cross-section having three axially extending cut portions. More specifically, the other end of the pilot pin 36 is provided on the outer periphery thereof with a chamfered portion 47 having three chamfered surfaces extending in the axial direction. The cross section of the chamfered portion 4 is substantially triangular. At the other end of the pilot pin 36, the three apexes form press-fit portions, and the three chamfered surfaces form, flow paths.

When the chamfered portion 4 is press-fitted into the passage 50 of the pilot body 37, which is a central fitting hole, three axially extending passages 47A are formed between the chamfered portion 47 and the inner wall of the passage 30.

The pilot body 37 is in the shape of a substantially bottomed circular cylinder having a bottom 3 A in the middle thereof. The pilot body 37 has a passage 50 extending through the center of the bottom 37A. The chamfered portion 47 of the pilot pin 36 is press-fitted into the passage 50. The bottom 377A of the pilot body 37 abuts against the large-diameter portion 36A of the pilot pin 36 with a flexible disk 48 (described later) interposed therebetween. In this way, the pilot pin 36 secures the main valve 27 and the flexible disk 48 to the main body 35 and the pilot body 37, respectively. The pilot body 37 has a circular cylindrical portion 37B at one end thereof. The sliding sealing member 45 of the main disk valve 41 is slidably and fluid-tightly fitted to the inner peripheral surface of the cylindrical portion 37B. Thus, a back-pressure chamber 49 is formed at the back of the main disk valve 41. The main disk valve 41, when receiving the passage 38-side pressure, lifts from, the seat portion 39 to open. At this time, the passages 38 communicate with the chamber 25B in the casing 25, which is downstream of the main disk valve 41. The pressure in the back-pressure chamber 49 acts on the main in disk valve 41 in the direction for closing the valve 41.

The pilot body 37 has passages 51 extending through the bottom 37A thereof. A seat portion is provided around the openings of the passages 51 to project toward the flexible disk 48. The flexible dish 48 is seated on the seat portion. The flexible disk 48 deflects in response to the pressure in the back-pressure chamber 49, thereby applying volumetric elasticity to the back-pressure chamber 49. Thus, the flexible disk 48 prevents the pressure in the back-pressure chamber 49 from excessively increasing during the valve-opening operation of the main disk valve 41, which would otherwise cause the valve-opening operation of the main disk valve 41 to become unstable. The flexible disk 48 has diametrically extending elongated notches 52 formed on the inner peripheral edge of the disk 48A, which abuts against the pilot pin 36. Passages 47A are formed between the chamfered portion 47 of the pilot pin 36 and the inner wall of the passage SO in the pilot body 37. The back-pressure chamber 49 and the passage 50 are communicated with each other through the notches 52 and the passages 47A.

The pilot body 37 has a valve chamber 54 formed in a circular cylindrical portion 37C at the other end thereof. The bottom 37A of the pilot body 37 has an annular seat portion 55 projecting toward a pilot valve member 56 (described later) at the peripheral edge of the opening of the passage 50. The valve chamber 54 is provided therein with a pilot valve 28 that selectively unseats from and seats on the seat portion 55 to open and close the passage 50. The pilot valve 28 has a pilot valve member 56 as a valving element. The pilot valve member 56 is substantially circular cylindrical and tapered at a distal end portion thereof that selectively seats on and unseats from the seat portion 55. The pilot valve member 56 has a flange-shaped spring retaining portion 5 of large diameter on the outer periphery of the proximal end thereof. The pilot valve number 56 has a rod-receiving portion 58 of small diameter on the inner periphery of the distal end thereof. The inner peripheral edge of the opening at the rear of the pilot valve member 56 is gradually enlarged in diameter to form a tapered portion 56A.

The pilot valve member 56 is resiliently retained axially movably opposite the seat portion 55 by a pilot spring 59 as an urging member, a fail-safe sparing 60, and a fail-safe disk 61. The cylindrical portion 37C at the other end of the pilot body 37 has an inner diameter stepwisely increasing toward the opening end thereof, thereby forming two step portions 62 and 63 on the inner periphery thereof. The radially outer end portion of the pilot spring 59 is supported by the step portion 62. On the step portion 63 is disposed a stack of a fail-safe spring 60, an annular retainer 64, a fail-safe disk valve 61, a retainer 65, a spacer 66, and a retaining plate 67. A cap 58 is fitted to the end of the cylindrical portion 37C to secure the pilot valve member 56, the pilot spring 59, the fail-safe spring 60, the annular retainer 64, the fail-safe disk valve 61, the retainer 65, the spacer 66, and the retaining plate 67.

The solenoid assembly 31 comprises a solenoid case 71, a coil 72, cores 73 and 74 inserted in the coil 72, a plunger 75 guided by the cores 73 and 74, and a hollow actuating rod 76 connected to the plunger 75. The coil 72, the cores 73 and 74, the plunger 75, and the actuating rod 76 are incorporated in the solenoid case 71 as one unit. The components of the solenoid assembly 31 are secured to each other by an annular spacer 7 and a cup-shaped cover 78, which are attached to the rear end of the solenoid case 71 by caulking. The coil 72, the cores 73 and 14, the plunger 75, and the actuating rod 76 constitute in combination a solenoid actuator. When the coil 72 is supplied with an electric current through a lead wire (not shown), axial thrust is generated in the plunger 75 according to the supplied electric current. The distal end of the actuating rod 76 has an outer peripheral edge. The actuating rod 76 has a tapered portion 76A formed on the outer peripheral edge thereof, and thus the distal end of the actuating rod 76 is tapered. The actuating rod 76 has a communicating passage 76B formed in its hollow inside. The communicating passage 76B provides communication between the passage 50 and the valve chamber 54, on the one hand, and, on the other, a chamber at the rear of the actuating rod 76. The plunger 75 is provided with communicating passages 757A communicating between two chambers formed at the opposite ends of the plunger 75. The communicating passages 76B and 75A allow balancing of the fluid forces acting on the actuating rod 76 and the plunger 75 and also apply appropriate damping force to the movement of the actuating rod 76 and the plunger 75.

The solenoid case 71 has at one end thereof a circular cylindrical portion 71A that is fitted into the casing 25. The cylindrical portion 71A is fitted therein with a projecting portion on the outer periphery of the cap 68 attached to the pilot body 37. The area between the cylindrical portion 71A and the casing 25 is sealed with an O-ring 80. The solenoid case 71 is connected to the valve block 30 as follows. First, the distal end of the actuating rod 76, which projects into the cylindrical portion 71A, is inserted into the pilot valve member 56 incorporated, in the valve block. 30 such that the distal end of the actuating rod 76 abuts against the rod-receiving portion 58. Next, the projecting portion on the outer periphery of the cap 63, which is attached to the pilot body 37, is fitted into the cylindrical portion 71A. In this way, the solenoid case 71 is connected to the valve block 30. The solenoid case 71 has a retaining ring 31 fitted in a groove on the outer periphery thereof. The solenoid case 71 is secured to the casing 25 by holding the retaining ring 81 with the nut 34.

FIG. 2 shows the damping force generating mechanism 26 when the coil 72 is not energized in a state where the valve block 30 and the solenoid assembly 31 have been connected and the actuating rod 76 has been inserted into the pilot valve member 56. When the coil 72 is not energized, as shown in FIG. 2, the pilot valve member 56 is retracted, together with the actuating rod 76, by the spring force of the fail-safe spring 60, so that the spring retaining portion 57 abuts against the fail-safe disk 61. At this time, the pilot spring 59 applies no spring force to the pilot valve member 56. When the coil 72 is energized, the actuating rod 76 presses the pilot valve member 56 to advance toward the seat portion 55. As a result, the pilot valve member 56 seats on the seat portion 55 against the spring forces of the fail-safe spring 60 and the pilot spring 59. At this time, the valve-opening pressure of the pilot valve member 56 can be controlled according to the electric current supplied to the coil 72.

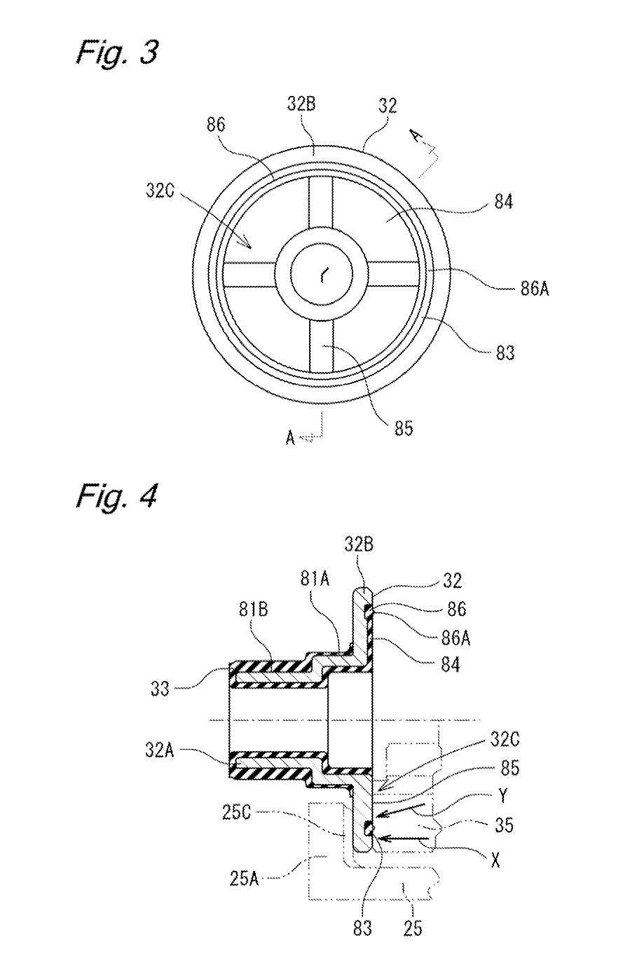

Next, the passage member 32 of the damping force generating mechanism 26 will be explained in more detail with reference to FIGS. 3 and 4.

As shown in FIGS. 3 and 4, the passage member 32 has a substantially circular cylindrical portion 32A and a flange portion 32B formed integrally on the outer periphery of one end of the cylindrical portion 32A. The cylindrical portion 32A is formed in the shape of a stepped circular cylinder having a large-diameter portion 81A at one end thereof where the flange portion 32B is formed, and a small-diameter portion 81B at the other end of the cylindrical portion 32A. The passage member 32 is partly covered with a sealing material 33 made of rubber. That is, the sealing material 33 covers the inner and outer peripheries of the cylindrical portion 32A, the distal end of the cylindrical portion 32A, and a part of an abutting surface 32C of the flange portion 32B that abuts against the main body 35. The sealing material 33 covering the outer periphery of the small-diameter portion 8IB of the cylindrical portion 32A forms a branch pipe sealing portion sealing between the branch pipe 23 and the small-diameter portion 81B. The abutting surface 32C of the flange portion 32B has an annular seal groove 83 formed at a position closer to the outer periphery thereof. The abutting surface 32C further has a plurality (four in the illustrated example) of circumferentially equally spaced support portions 85 extending from the inner periphery of the seal groove 83 to the inner periphery of the flange portion 32B. The support portions 85 are flush with the flange portion 32B at the outer peripheral side of the seal groove 83. Thus, the abutting surface 32C is provided with four substantially sectorial radial grooves 84 surrounded by the seal groove 83 and the support portions 85.

The sealing material 33 covering the passage member 32 extends from the inner surface of the cylindrical portion 32A so as to cover the radial grooves 84 and the seal groove 83. The sealing material 33 filled in the seal groove 83 forms a sealing member 36 sealing between the flange portion 32B and the main body 35. The sealing member 86 has a lip portion 86A projecting from the center thereof. The sealing material 33 is fixed to the passage member 32 by vulcanization bonding or the like. Thus, the sealing material 33 is fixed to the passage member 32 integrally continuously over the cylindrical portion 32A, including the branch pipe sealing portion, and further over the flange portion 32B and the seal groove 83. Accordingly, when the sealing material 33 is fixed to the passage member 32 by vulcanization bonding, for example, it is possible to fix the sealing material 33 to the passage member 32 in one operation and therefore possible to improve productivity. It should be noted that, in this embodiment, the support portions 85 are not covered with, the sealing material 33, but may be covered therewith. Further, in this embodiment, the radial grooves 84 are covered with the sealing material 33. The radial grooves 84, however, need not always be covered with the sealing material 33 because sealing between the passage member 32 and the main body 35 is performed by the sealing member 86 fitted in the seal groove 83.

Thus, the abutting surface 32C of the flange portion 32B of the passage member 32 is formed with a sealing portion abutting against the main body 35 through the sealing member 86 in the seal groove 83, which is provided at a position closer to the outer periphery of the abutting surface 32C, and further formed with support portions 85 (excluding the radial grooves 84 covered with the sealing material 33) that abut directly against the main body 35 at the inner peripheral side of the sealing portion,

The following is an explanation of the operation of the damping force control type shock absorber 1 structured as stated above.

The damping force control type shock absorber 1 is installed between sprung and unsprung members of a suspension system of a vehicle. In a normal operating condition, the coil 72 is energized by an in-vehicle controller, causing the pilot valve member 56 to seat on the seat surface of the pilot body 37 to execute pressure control by the pilot valve 28.

During the extension stroke of the piston rod 6, the movement, of the piston 5 in the cylinder 2 closes the check valve 13 of the piston 5. Before the disk valve 14 opens, the fluid in the cylinder upper chamber 2A is pressurized to flow through the passage 22 and the annular passage 21 into the passage member 32 of the damping force generating mechanism 26 from the branch pipe 23 of the separator tube 20.

At this time, an amount of hydraulic oil corresponding to the amount of movement or the piston 5 flows into the cylinder lower chamber 2B from the reservoir 4 by opening the check valve 1 of the base valve 10. It should be noted that, when the pressure in the cylinder upper chamber 2A reaches the valve-opening pressure of the disk valve 14 of the piston 5, the disk valve 14 opens to relieve the pressure in the cylinder upper chamber 2A into the cylinder lower chamber 2B, thereby preventing an excessive increase in pressure in the cylinder upper chamber 2A.

In normal condition, the coil 72 is supplied, with an electric current, causing the pilot valve member 56 to move toward the seat portion 55. Even in normal condition, when the supplied electric current is low (e.g. not higher than 0.5 A; the electric current flows through the solenoid in the range of from 0.3 A to 1.5 A), the pilot valve member 56 cannot be seated on the seat portion 55 because the spring force of the pilot spring 59 is stronger than the solenoid force.

In the damping force generating mechanism 26, the hydraulic oil flowing in from the passage member 32 flows as follows. Before the main disk valve 41 of the main valve 27 opens (in the low piston speed region), the hydraulic oil flows through the orifice passage 46 in the pilot pin 36 and the passage 50 in the pilot body 37 and pushes open the pilot valve member 56 of the pilot valve 28 to flow into the valve chamber 54. From the valve chamber 54, the hydraulic oil further passes through the opening of the fail-safe disk 65 and flows into the reservoir 4 through the opening 6A of the retaining plane 67, the notches 70A of the cap 68, the chamber 25B in the casing 25, and the notches 25C formed on the flange portion 25A of the casing 25, When the piston speed increases and the pressure in the cylinder upper chamber 2A reaches the valve-opening pressure of the main disk valve 41, the hydraulic oil flowing into the passage member 32 passes through the annular recess 100 and the passages 38 and pushes open the main disk valve 41 to flow directly into the chamber 25B in the casing 25.

During the compression stroke of the piston rod 6, the movement of the piston 5 in the cylinder 2 opens the check valve 13 of the piston 5 and closes the check valve 17 for the passage 15 of the base valve 10. Before the disk, valve 18 opens, the fluid in the cylinder lower chamber 2B flows into the cylinder upper chamber 2A, and an amount of fluid corresponding to the amount by which the piston rod 6 enters the cylinder 2 flows from the cylinder upper chamber 2A into the reservoir 4 through a flow path similar to that during the above-described extension stroke. It should be noted that, when the pressure in the cylinder lower chamber 2B reaches the valve-opening pressure of the disk valve 18 of the base valve 10, the disk valve 18 opens to relieve the pressure in the cylinder lower chamber 2B into the reservoir 4, thereby preventing an excessive increase in pressure in the cylinder lower chamber 28.

Thus, during both the extension and compression strokes of the piston rod 6, the damping force generating mechanism 26 operates as follows. Before the main disk valve 41 of the main valve 2 opens (in the low piston speed region), damping force is generated according to the flow path area of the orifice passage 46 and the area of flow path between the pilot valve member 56 of the pilot valve 23 and the seat portion 55. After the main disk valve 41 has opened (in the high piston speed region), damping force is generated according to the degree of opening of the main disk valve 41, The damping force can be controlled directly, independently of the piston speed, by adjusting the valve-opening pressure of the pilot valve 28 with the electric current supplied to the coil 72. In this regard, a variation in the valve-opening pressure of the pilot valve 28 causes a change in the pressure in the back-pressure chamber 43 communicating with the passage 50, which is upstream of the pilot valve 28, through the passages 47A formed by the chamfered portion 47 of the pilot pin 36 and through the notches 52 of the disk 48A. The pressure in the back-pressure chamber 49 acts in the direction for closing the main disk valve 41. Therefore, by controlling the valve-opening pressure of the pilot valve 28, the valve-opening pressure of the main disk valve 41 can be controlled simultaneously, and hence the controllable range of damping force characteristics can be widened.

In addition, when the electric current supplied to the coil 72 is reduced to reduce the thrust of the plunger 75, the valve-opening pressure of the pilot valve 28 lowers, and soft damping force is generated. When the electric current supplied to the coil 72 is increased to increase the thrust of the plunger 75, the valve-opening pressure of the pilot valve 28 rises, and hard damping force is generated. Accordingly, soft damping force, which is generally used frequently, can be generated with a reduced electric current, and the power consumption can be reduced.

In the event that the thrust of the plunger 75 is lost because of a failure such as disconnection of the coil 72 or a trouble in the in-vehicle controller, the pilot, valve member 56 is retracted by the spring force of the fail-safe spring 60. As a result, the passage 50 opens. Meanwhile, the spring retaining portion 57 of the pilot valve member 56 abuts against the fail-safe disk 61 to close the flow path between the valve chamber 54 and the chamber 25B in the casing 25.

In this state, the fail-safe valve 23 controls the flow of hydraulic oil in the valve chamber 54 from the passage 50 to the chamber 25B in the casing 25. Therefore, by properly setting the valve-opening pressure of the fail-safe disk 61, a desired damping force can be generated and it is possible to adjust the pressure in the back-pressure chamber 49, i.e. the valve-opening pressure of the main disk valve 41. Thus, an appropriate damping force can be obtained even in the event of a failure.

During assembly of the damping force generating mechanism 26, the flange portion 32B of the passage member 32 is pressed against the flange portion 25A of the casing 25 through the main body 35 with an axial force applied thereto by tightening the nut 34. Consequently, the passage member 32 is secured between the main body 35 and the flange portion 25A. At this time, the axial force (i.e. a force acting in the axial direction) is transmitted mainly to the center and its vicinities of the main body 35 because the pilot pin 36 transmitting the axial force to the main body 35 is small in diameter. When the axial force is transmitted from the main body 33 to the passage member 32, as shown by the arrows X and Y in FIG. 4, the axial force is transmitted mainly to the support portions 85, which abut directly on the main body 35. Therefore, the axial force applied to the main body 35 mainly comprises the axial force shown by the arrow Y, which is transmitted to the center and its vicinities of the main body 35.

The axial force Y is a force applied to the main body 35 and the passage member 32 through the cap 68, the pilot body 37, and the pilot pin 36 when the nut 34 is tightened. Because the pilot pin 36 is small in diameter, the axial force Y is applied obliquely to the main body 35.

Accordingly, in a structure where the axial force is transmitted mainly to the center and its vicinities of the main body 35 as shown in this embodiment, an axial force support portion may be formed from, only the support portions 85, which are radially inside the seal groove 83. In such a case, the support portions 85, which are radially inside the seal groove 83, may be made higher in projecting height than the region of the flange portion 32B that is radially outside the seal groove 83. That is, the passage member 32 may be configured so that only the support portions 85 abut against the main body 35. The axial force is also transmitted to the flange portion 32B from the outer peripheral portion of the seal groove 83. Thus, the axial force transmitted from the pilot pin 36, which is small in diameter, is transmitted efficiently from the center and its vicinities of the main body 35 to the flange portion 25A of the casing 25 through the support portions 85 (center and its vicinities) at the inner peripheral side of the seal groove 83 of the flange portion 32B of the passage member 32. Consequently, the main body 35 can be reduced in thickness in the axial direction thereof, and it becomes possible to reduce the size and weight of the damping force generating mechanism 26. In addition, the main body 35 can be produced easily by sintering, and it is therefore possible to reduce manufacturing cost.

In this regard, in a structure where a sealing member is disposed in a recess formed in an inner peripheral portion of the flange portion 32B of the passage member 32 as disclosed in Japanese Patent Laid-Open Publication No. 2013-11342, an axial force transmitted from the pilot pin 36 to the center and its vicinities of the main body 35 by tightening the nut 34 is transmitted from an outer peripheral region of the main body 35 to an outer peripheral region, of the flange portion 32B of the passage member 32 but not to the recessed region of the flange portion 32B. Accordingly, the main body 35 is easily deflectable and needs to be increased in thickness in the axial direction in order to obtain necessary rigidity.

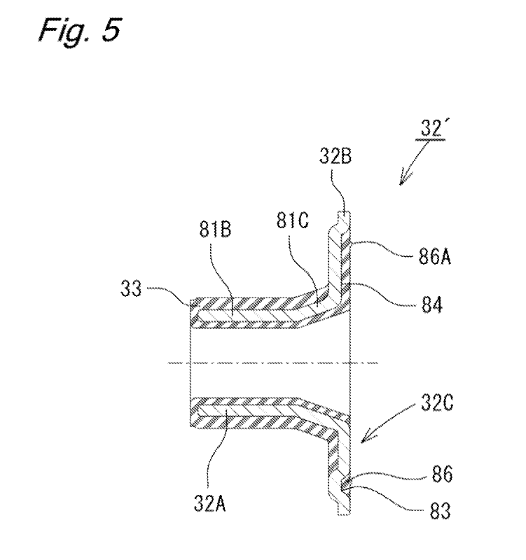

Next, a modification of the passage member 32 in the above-described, embodiment will be explained with reference to FIG. 5. It should be noted that, in the following explanation, members or portions similar to those of the above-described embodiment are denoted by the same reference numerals as in the foregoing embodiment, and that only the points in which the modification differs from the described embodiment will be explained in detail.

As shown in FIG. 5, a passage member 32′ according to the modification is produced by press-forming a plate material. Therefore, the passage member 32′ is smaller in plate thickness than the passage member 32 in the foregoing embodiment. In addition, the back of the passage member 32′ is convexly protruded at each of portions of the passage member 32′ where the seal groove 83 and the radial grooves 84, which are concave in cross section, are formed. Further, a tapered portion 81C is formed in place of the large-diameter portion 81A of the cylindrical portion 32A. With this structure, the modification offers operational advantages similar to those of the foregoing embodiment.

Although in the foregoing embodiment the sealing member 86 in the seal groove 83 of the passage member 32 is formed integrally with the sealing material 33 covering the passage member 32, the sealing member 86 may be formed separately from the sealing material 33. Alternatively, an existing sealing member such as an O-ring may be used in place of the sealing member 86.

Further, although the sealing member 86 in the foregoing embodiment is circularly annular, the configuration of the sealing member 86 is not limited thereto but may be quadrangular or any other loop shape. However, the circularly annular sealing member 86 allows radial displacement of the main body 35 relative to the passage member 32; therefore, assembleability can be improved. More specifically, after the branch pipe 23 formed on the separator tube 20 has been roughly aligned with the opening 24 of the outer tube 3, the passage member 32 is fitted into the branch pipe 23 and secured to the separator tube 20 while the valve block 30 is being pressed against the passage member 32. At this time, because the sealing member 86 is circularly annular, it is possible to increase the tolerance on radial movement of the valve block 30 relative to the flange portion 328 of the passage member 32, and hence possible to tolerate an alignment error daring assembly.

Any features of the embodiments can be combined.

According to the present invention, it becomes possible to reduce the size of a tube type shock absorber having a damping force generating mechanism disposed at a side of a cylinder part.

Although only some exemplary embodiments of this invention have been described in derail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2013-163639 filed on Aug. 2, 2013.

The entire disclosure of Japanese Patent Application No. 2013-166639 filed on Aug. 9, 2013 including specification, claims, drawings and summary are incorporated herein by reference in its entirety.

What is claimed is:

1. A shock, absorber comprising:
a cylinder having a hydraulic fluid sealed therein; a piston fitted in the cylinder;
a piston rod connected to the piston and extended to an outside of the cylinder;
an outer tube provided around an outer periphery of the cylinder;
a separator tube provided between the cylinder and the outer tube, the separator tube having a substantially circular cylindrical side wall forming an annular passage communicating with en interior of the cylinder;
a substantially circular cylindrical branch pipe provided on the side wall of the separator tube to project radially outward, the branch pipe communicating with the annular passage;
a damping force generating mechanism connected, to the branch pipe to generate a damping force by controlling a flow of hydraulic fluid induced by movement of the piston;
a tubular casing secured to a side wall, of the outer tube to house the damping force generating mechanism; and
a passage member connecting together the branch pipe and the damping force generating mechanism;
the passage member having a circular cylindrical portion fitted to the branch pipe of the separator tube, the passage member further having a flange portion formed on an outer periphery of one end of the cylindrical portion;
the passage member being secured in the casing with the flange portion abutted between the casing and the damping force generating mechanism;
the flange portion having an abutting surface abutting against the damping force generating mechanism;
the abutting surface having an annular sealing portion abutting against the damping force generating mechanism through an annular sealing member sealing between the flange portion and the damping force generating mechanism, the abutting surface further having an inner support portion disposed at an inner peripheral side of the sealing portion to abut against the damping force generating mechanism.

2. The shock absorber of claim 1, wherein the sealing portion includes an annular seal groove and a sealing member fitted in the seal groove.

3. The shock absorber of claim 1, wherein the passage member has a branch pipe sealing portion covering at least a part of the cylindrical portion to seal between the cylindrical portion and the branch pipe, the branch pipe sealing portion being formed integrally with the sealing member,

4. The shock absorber of claim 2, wherein the passage member has a branch pipe sealing portion covering at least a part of the cylindrical portion to seal between the cylindrical portion and the branch pipe, the branch pipe sealing portion being formed integrally with the sealing member.

5. The shock, absorber of claim 1, wherein the passage member is a press-formed article.

6. The shock absorber of claim 1, wherein the inner support, portion is separate from the passage member.
